(19) United States
(12) Patent Application Publication
(10) Pub. No.: US 2016/0069258 A1
(43) Pub. Date: Mar. 10, 2016

(54) TURBINE SYSTEM

(71) Applicant: SIEMENS AKTIENGESELLSCHAFT, Munchen (DE)

(72) Inventors: Julian TIMMERMANN, Gelsenkirchen (DE); Olga DEISS, Dusseldorf (DE); Reinhard SCHILP, Orlando, FL (US)

(21) Appl. No.: 14/478,090

(22) Filed: Sep. 5, 2014

(51) Int. Cl. F02C 3/04; F02C 7/04

(52) U.S. Cl. CPC F02C 3/04; F02C 7/04

(57) ABSTRACT

A turbine system including a compressor (3), a combustor arrangement having several combustors (4) fluidicallys connected to receive air from the compressor (3), and a turbine (5) fluidically connected to the combustors (4). Each combustor (4) has an air inlet ring chamber (7) with a flow cross-section defined by an inner tube (10) and an outer tube (11; 17) around the inner tube. The air inlet ring chamber is configured to introduce compressed air from the compressor (3) into the combustor (4). A radial distance (d) between the inner tube (10) and the outer tube (11; 17) of each air inlet ring chamber (7) at least partially varies along the circumference of the air inlet ring chamber (7).

### TECHNICAL FIELD

The present invention relates to a turbine system comprising a compressor, a combustor arrangement having several combustors fluidically connected to said compressor, and a turbine fluidically connected to said combustors , wherein each of the combustors respectively comprises an air inlet ring chamber having a flow cross-section defined by an inner tube and a surrounding outer tube through which compressed air from the compressor is introduced into the respective combustor.

### TECHNICAL BACKGROUND

Turbine systems of the above-mentioned kind are known in prior art. FIG. 8 shows an example of a known turbine system 100 comprising a multi-part housing 101, a compressor 102 arranged within the housing 101, a combustor arrangement having several combustors 103 installed in the housing 101 and fluidically connected to the compressor 102, and a turbine 104, which is arranged within the housing 101 and fluidically connected to transition ducts 105 of the combustors 103. Each combustor 103 comprises an air inlet ring chamber 106, through which compressed ambient air generated in the compressor 102 is introduced into the combustor 103, as indicated by arrows 107 and 108. Each air inlet ring chamber 106 is defined by an inner tube 109 and by an outer tube 110. The inner tube 109 is defined by an outer wall of a combustion chamber 111 of the associated combustor 103. The outer tube 110 is formed as a ring-shaped guiding plate. The inner tube 109 and the outer tube 110 both have a circular cross section and are arranged coaxially, wherein the central axes of the inner tube 109 and the outer tube 110 correspond to a central longitudinal axis 112 of the entire combustor 103.

During the operation of the gas turbine system 100 shown in FIG. 8, ambient air is compressed by means of the compressor 102 and is directed towards the combustors 103 as indicated by arrows 107 and 108. The compressed air enters the combustors 103 through their air inlet ring chambers 106. Within the burners 114, the compressed air is mixed with fuel, whereupon the created air-fuel-mixture is burned within the combustion chambers 111 of the combustors 103. The exhaust gases are directed towards the turbine 104 via the transition ducts 105 in order to drive the rotating vanes of the turbine 104. The construction of this known gas turbine system 100 is disadvantageous in that the compressed air does not enter the air inlet ring chambers 106 evenly along their circumferences due to nonuniform geometric conditions of the gas turbine system 100, such as different flow paths and flow angles of the compressed air on its way from the compressor 102 to the combustors 103. This leads to unevenly distributed flow rates and flow speeds within the air inlet ring chamber 106 negatively affecting the combustion of the air-fuel-mixture within the combustion chamber 111, which is not desirable.

### SUMMARY OF THE INVENTION

Starting from this prior art it is an object of the present invention to provide a gas turbine system of the above-mentioned kind having an alternative construction.

In order to solve this object the present invention provides a gas turbine system of the above-mentioned kind, which is characterized in that a radial distance between the inner tube and the outer tube of at least one air inlet ring chamber at least partially varies along the circumference of the air inlet ring chamber. Thanks to this construction an uneven incoming flow of compressed air can be homogenized within the inlet ring chambers of the combustors with respect to flow rate and flow speed. Accordingly, negative effects accompanied by an uneven incoming flow of compressed air can be minimized.

According to one aspect of the present invention said inner tube substantially has a circular cross-section and said outer tube has at least partly an oval cross-section.

Alternatively, the cross-section of said inner tube as well as the cross-section of said outer tube are substantially circular, wherein the longitudinal axis of said inner tube and of said outer tube are arranged with a radial displacement.

Both variants lead to a varying radial distance between the inner tube and the outer tube along the circumference of the air inlet ring chamber.

According to a further aspect of the present invention a flow cross-section of at least one air inlet ring chamber at least partly reduces in flow-direction asymmetrically with respect to a longitudinal axis of the inner tube. Thus, when compressed air is introduced in the air inlet ring chamber with different flow speeds along the circumference of the air inlet ring chamber, it is possible to homogenize the different flow speeds while the compressed air is passed through the air inlet ring chamber.

Preferably, an air inlet opening of at least one air inlet ring chamber is slanted with respect to a plane extending perpendicular to a longitudinal axis of the associated burner. This leads to different entering positions of the compressed air along the circumference of the air inlet ring chamber. Such different entering positions can also compensate or reduce differences in flow speed.

Preferably, the outer tubes of the air inlet ring chambers are each formed by a sleeve attached to the associated combustor. This is of advantage with respect to the production and the maintenance of the combustor.

According to one aspect of the present invention the inner tubes of the air inlet ring chambers are each formed by an outer wall of the combustion chamber of the associated combustor. This leads to a simple construction of the turbine system.

Further features and advantages of the present invention will become apparent by means of the following description of a turbine system according to an embodiment of the present invention with reference to the accompanying drawing.

### BRIEF DESCRIPTION OF THE DRAWINGS

FIG. 1 is a schematic cross-sectional view of a turbine system according to an embodiment of the present invention;

FIG. 2 is a schematic perspective view of an outer tube of an air inlet ring chamber of the gas turbine system shown in FIG. 1;

FIG. 3 is a schematic side view of the outer tube shown in FIG. 2;

FIG. 4 is a schematic front view of the air inlet ring chamber shown in FIG. 1;

FIG. 5 is a schematic perspective view of an alternative outer tube of an air inlet ring chamber according to the present invention;

FIG. 6 is a schematic side view of the outer tube shown in FIG. 5;

FIG. 7 is a schematic front view of the air inlet ring chamber and

FIG. 8 is a schematical perspective view of a known gas turbine system.

### DESCRIPTION OF EMBODIMENTS

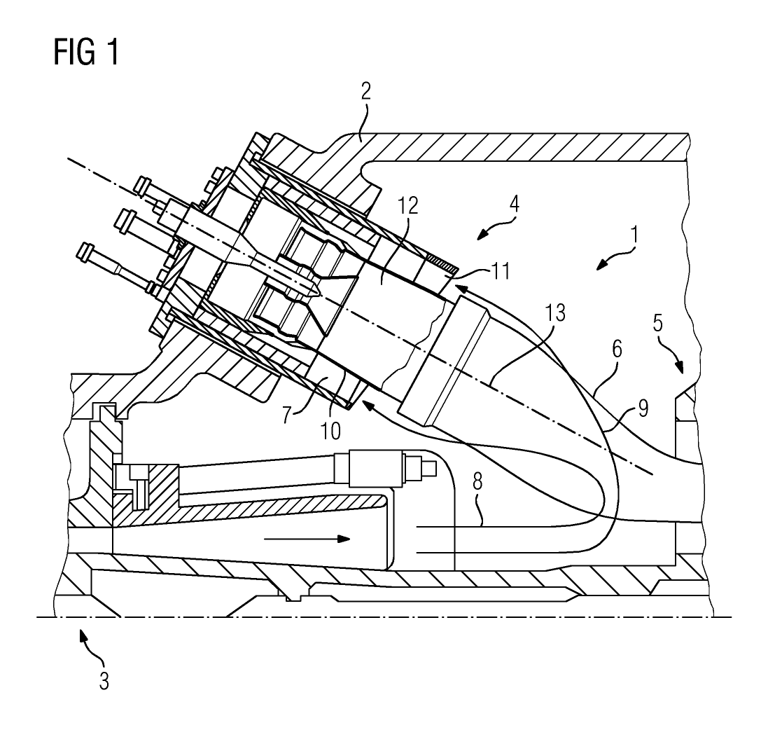

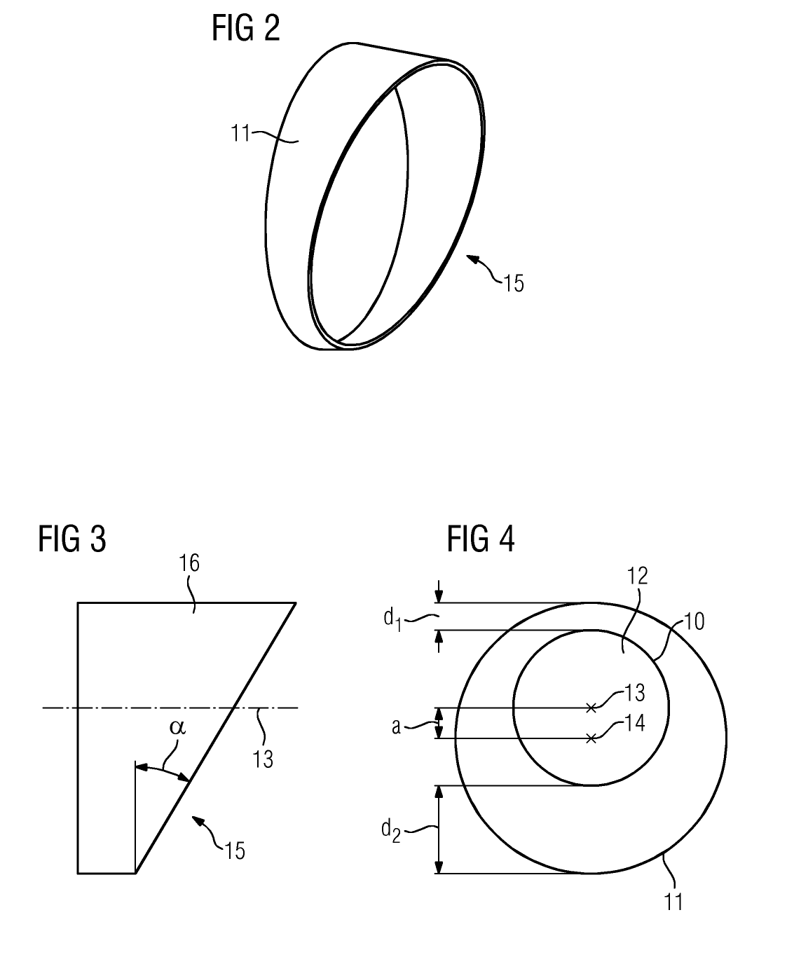

FIG. 1 to 4 shows a gas turbine system 1 according to an embodiment of the present invention. The gas turbine system 1 comprises a multi-part housing 2, a compressor 3 arranged within the housing 2, a combustor arrangement having separate combustors 4 inserted in the housing 2 and fluidically connected to the compressor 3, and a turbine 5, which is arranged within the housing 2 and fluidically connected to the transition ducts 6 of the combustors 4. Each combustor 4 comprises an air inlet ring chamber 7, through which compressed air from the compressor 3 is introduced into the respective combustor 4, as indicated by arrows 8 and 9. The air inlet ring chambers 7 are defined by an inner tube 10 and by an outer tube 11. The inner tube 10 is formed by an outer wall of a combustion chamber 12 of the associated combustor 4. The outer tube 11 is defined by a ring-shaped guiding plate, which is designed as a separate sleeve being fixed to the associated combustor 4 by means of welding or the like. In one embodiment, the inner tube 10 and the outer tube 11 of at least one of the air inlet ring chambers 7 both have a circular cross-section, wherein the longitudinal axis 13 of the inner tube 10 and the longitudinal axis 14 of the outer tube 11 are arranged with a radial displacement a. Thus, a radial distance between the inner tube 10 and the outer tube 11 of the air inlet ring chamber 7 varies along the circumference of the air inlet ring chamber 7, as is illustrated by d₁ and d₂. Moreover, an air inlet opening 15 into each air inlet ring chamber is slanted with respect to a plane 16 extending perpendicular to the longitudinal axis 13 of the inner tube 10, which corresponds to the longitudinal axis of the associated combustor 4, by an angle α.

During the operation of the gas turbine system 1 shown in FIG. 1 ambient air is compressed by means of the compressor 3 and is directed towards the combustor 4 as indicated by arrows 8 and 9. The compressed air enters the combustor 4 through the air inlet ring chambers 7. Thanks to an adequate choice of the geometry and the arrangement of each air inlet ring chamber 7, in particular with respect to the radial displacement d of the longitudinal axes 13 and 14 of the inner tube 10 and the outer tube 11 of each air inlet ring chamber 7, with respect to the slanted air inlet openings 15 of each air inlet ring chambers 7 and with respect to the rotational orientation of each air inlet ring chamber 7 and the associated combustor 4, the flow speeds and the flow rates of the compressed air led through the air inlet ring chambers 7 are homogenized along the circumference of the respective air inlet ring chambers 7, even though the incoming compressed air does not blow evenly against the air inlet openings 15 of the ring chambers 7. Thus, positive effects on the combustion and on the emissions can be achieved.

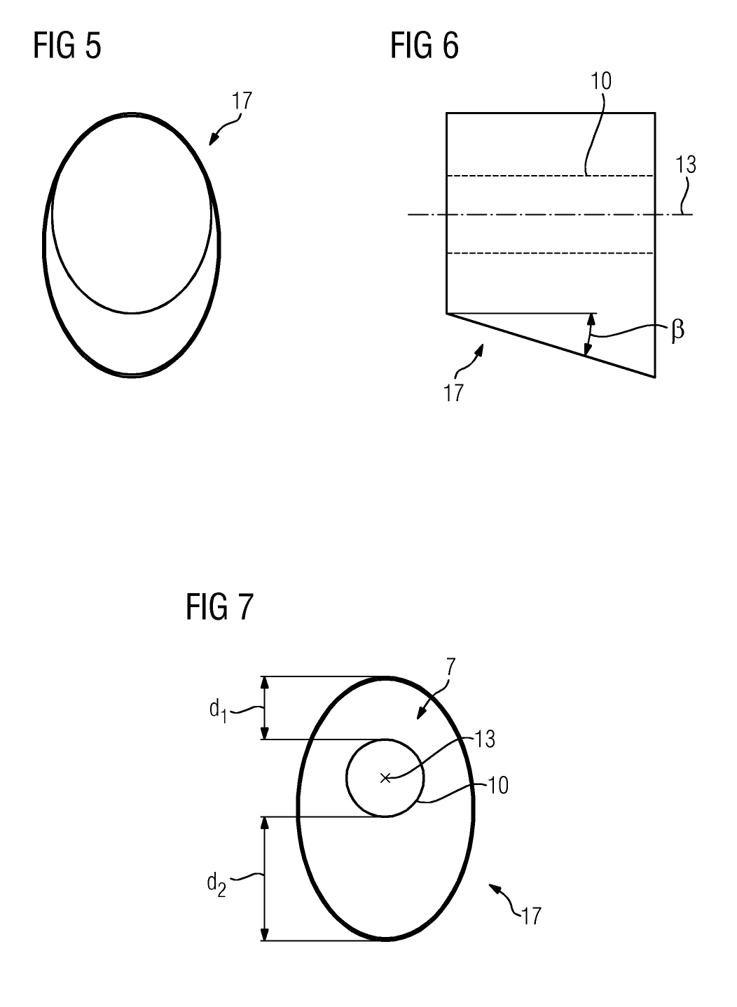

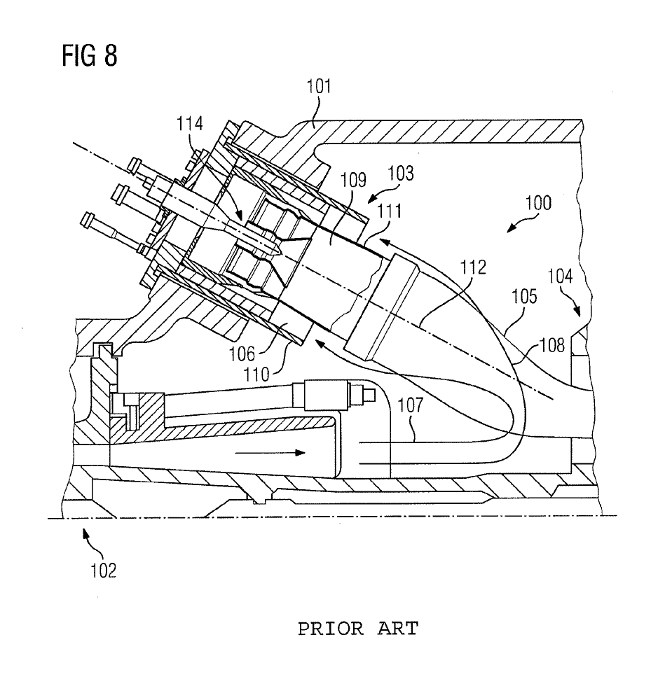

FIGS. 5 to 7 show an alternative outer tube 17 of the air inlet ring chamber according to the present invention, which may be used in at least one of the combustors instead of the outer tube 11 in order to form an air inlet ring chamber 7 together with an above-described inner tube 10 as shown in FIG. 1. The outer tube 17 is also defined by a ring-shaped guiding plate, which is fixed to an associated combustor 4 and surrounds the inner tube 10. However, in contrast to the outer tube 11, the outer tube 17 has an oval cross section, which leads to a varying radial distance d between the inner tube 10 and the outer tube 17 along the circumference of the air inlet ring chamber 7, as shown by d₁ and d₂. Moreover, the lower half of the outer tube 17 is axially slanted with respect to the longitudinal axis 13 of the inner tube 10 by an angle β, such that a flow cross-section created between the inner tube 10 and the lower half of the outer tube 17 reduces in flow-direction, while the flow cross-section created between the inner tube 10 and the upper half of the outer tube 17 remains unchanged. Accordingly, compressed air, which is led through the lower half of the air inlet ring chamber 7 with the reducing flow cross-section, is accelerated in order to adapt the flow speed to the one of the compressed air, which is led through the upper half of the air inlet ring chamber 7.

It should be clear, that the above-described embodiments are not to be understood as limiting the scope of protection of the present invention, which is defined by the accompanying claims.

1. A turbine system comprising:
a compressor, a combustor arrangement having several combustors each fluidically connected to the compressor to receive compressed air, and a turbine fluidically connected to the combustors for the combustors to drive the turbine;
each combustor comprises an air inlet ring chamber having a flow cross-section, each air inlet ring chamber is defined by and between an inner tube and an outer tube around the inner tube; a fluid connection through which compressed air from the compressor is introduced into the air inlet ring chamber of each combustor;
there is a radial distance (d) in each air inlet ring chamber between the inner tube and the outer tube of the air inlet ring; and chamber and the radial distance of at least the one of air inlet ring chambers at least partially varies along a circumference of the at least one air inlet ring chamber.

2. A turbine system according to claim 1, wherein the inner tube of at least one of the air inlet ring chambers substantially has a circular cross-section and the outer tube of the at least the one air inlet ring chamber at least partly has an oval cross-section.

3. A turbine system according to claim 1, wherein a cross-section of the inner tube of at least one of the air inlet ring chambers and a cross-section of the outer tube of the at least one air inlet ring chamber are substantially circular, wherein longitudinal axes of the inner tube and the outer tube are arranged with a radial displacement (a).

4. A turbine system according to claim 1, wherein the flow cross-section of at least one air inlet ring chamber is at least partly reduced in a flow-direction asymmetrically with respect to a longitudinal axis of the inner tube of the at least the one air inlet ring chamber.

5. A turbine system according to claim 1, further comprising an air inlet opening of at least one air inlet ring chamber is slanted with respect to a plane extending perpendicular to a longitudinal axis of the at least one combustor.

6. A turbine system according to claim 1 wherein the outer tube of at least one air inlet ring chamber is formed by a sleeve attached to the at least one combustor.

7. A turbine system according to claim 1, further comprising the inner tube of at least one air inlet ring chamber is formed by an outer wall of a combustion chamber of the at least one combustor.
